(19) United States
(12) Patent Application Publication
(10) Pub. No.: US 2008/0244845 A1
(43) Pub. Date: Oct. 9, 2008

(54) Wipe for surface treatment so that a user can verify and/or monitor the effectiveness of said treatment

(75) Inventors: Martin Goibier, Plougoumelen (FR); Salvatore Augeri, Vannes (FR)

Correspondence Address: YOUNG & THOMPSON, 209 Madison Street, Suite 500, ALEXANDRIA, VA, 22314, US

(73) Assignee: SOCIETE DE PRODUITS CHIMIQUES DE L'QUEST ET DU MORBIHAN, VANNES (FR)

(21) Appl. No.: 11/783,010

(22) Filed: Apr. 5, 2007

(51) Int. Cl. B08B 13/00; B05D 5/00

(52) U.S. Cl. 15/104.93; 427/157

(57) ABSTRACT

A wipe for surface treatment includes a substrate that is impregnated with a surface treatment solution, characterized in that the wipe includes at least one light-emitting agent, whereby the light-emitting agent is soluble in the surface treatment solution and visible at least under predetermined conditions so that a user can verify and/or monitor the treated and/or non-treated areas of the surface. A process for the production of the wipe is also disclosed.

This invention relates to a wipe that is intended to be used for the treatment of a contaminated surface, allowing not only the treatment of said surface but also the verification and/or monitoring of the effectiveness of said treatment.

More particularly, this invention relates to a wipe that makes it possible to prepare a contaminated surface for receiving a coating that is intended to adhere to the surface and to verify with the naked eye if said surface has been treated in its entirety by said surface treatment agent.

The invention also has as its object a process for the production of said wipe.

In numerous fields, such as that of metallurgy, the automobile industry, aeronautics, construction, in particular regarding the operations for surface preparation before painting or gluing, it is necessary to have a neat and well-cleaned surface.

The document U.S. Pat. No. 5,688,394 is known according to the prior art. This document describes a wipe distributor that contains liquid solvents such as volatile organic compounds (VOC). These volatile organic compounds can be inserted into, the distributor for example, by impregnation of the wipes previously placed in said distributor. The objective of this distributor is to remove the contaminants from the surfaces using VOC before a subsequent coating is applied, for example before the body of a car or an airplane is painted. In this case, there is no way to verify the effectiveness of the desired cleaning. It is the same when the cleaning is carried out with a simple cloth that is saturated with a surface treatment solution.

Thus, the standard surface treatment products, regardless of whether they are in liquid form or in wipe form, do not make it possible, after implementation by a user, to monitor and/or to verify instantaneously or a posteriori if the surface in its entirety was treated so as to obtain a totally treated surface in an effective manner.

The invention has as its object to propose a wipe that is designed to be used for the treatment of a surface that has numerous qualities and that makes it possible to partially avoid the above-mentioned drawbacks. More particularly, the invention has as its object to propose a wipe that makes it possible to verify if a surface that is to be prepared for a subsequent use has been completely treated.

The invention thus relates to a wipe for surface treatment, whereby said wipe comprises a substrate that is impregnated with a surface treatment solution, characterized in that said wipe comprise at least one light-emitting agent, whereby said light-emitting agent is soluble in the surface treatment solution and visible at least under predetermined conditions, so that a user can verify and/or monitor the treated and/or non-treated areas of said surface.

Another object of the invention relates to a process for production of a wipe according to one of the characteristics above comprising at least the steps consisting in:
a) Dissolving a light-emitting agent that is visible at least under predetermined conditions in a surface treatment solution,
b) Impregnating up to a predetermined level said wipe with the solution that is obtained, whereby the impregnation is done so as to distribute said solution homogeneously over said wipe,
c) Packaging said wipe that is impregnated in an airtight package that is compatible with said solution,
   whereby steps b) and c) can be carried out in any order.

The invention will be better understood and other purposes, details, characteristics and advantages of the latter will emerge more clearly during the detailed explanatory description that will follow from an embodiment of the invention, intended to be purely illustrative and nonlimiting.

As indicated above, the invention relates to a wipe for surface treatment, whereby said wipe comprises a substrate that is impregnated with a surface treatment solution. Said wipe is characterized in that it comprises at least one light-emitting agent, whereby said light-emitting agent is soluble in the surface treatment solution and visible at least under predetermined conditions, such that a user can verify and/or monitor the treatment, i.e., the treated and/or non-treated areas of said surface.

“Wipe” is defined as any substrate made of any material that is saturated with a product that can be used in particular in dusting, drying off, cleaning, degreasing or else cleaning off a surface, preferably an inert surface. The substrate of said wipe according to this invention is thus preferably composed of a non-woven material, a woven material, a knitted material or a composite film. Advantageously, the substrate of the wipe suitable for this invention is a non-woven material. The substrate of said wipe can be made of, for example, natural or synthetic fibers. These fibers are preferably fibers of polyester, polypropylene, polyamide, viscose, rayon or other cellulose derivatives. Other fibers, such as cotton or wool fibers, could also be used.

The predetermined conditions that make it possible for a user to monitor and/or to verify the effectiveness of the treatment of a surface with the naked eye can be produced by, for example, a fluorescent compound that absorbs the invisible UV radiation and that emits visible light radiation or a phosphorescent compound, in particular so as to be detected. The fluorescent compounds actually make it possible by the emission of visible light from an invisible energy source—such as an ultraviolet source—to make fluorescent objects appear brighter than objects that are of the same color, but are not fluorescent.

Contrary to the fluorescent compounds, the phosphorescent compounds emit light during and after having been illuminated.

More particularly, the fluorescent or phosphorescent compounds that are suitable for this invention may have an absorption spectrum in the UV range of about 10 nm to 380 nm and a spectrum in the visible range of about 380 nm to 750 nm.

In addition, the fluorescent or phosphorescent compound should exhibit a good adhesion with the surface to be treated and in particular to be cleaned.

Thus, the fluorescent or phosphorescent compounds can be selected from among, but without limiting thereto, the 2,5-thiophenediylbis(5-tert-butyl-1,3-benzoxazole) or else the 4,4′-bis(2-sulfostyryl)-biphenyl disodium salt.

The 2,5-thiophenediylbis(5-tert-butyl-1,3-benzoxazole) may be, for example, the product that is marketed under the trademark Uvitex® OB by the CIBA Company, and the 4,4′-bis(2-sulfostyryl)-biphenyl disodium salt can be, for example, the product that is marketed under the trademark Uvitex® NFW by the CIBA Company.

This invention consequently makes it possible to verify and/or to monitor by a simple means, for example under UV radiation, and at low cost if the contaminated surface to be treated and intended to subsequently receive a coating, such as a layer of paint, was effectively and in its entirety treated, for example cleaned.

The light-emitting agent according to this invention is present in the surface treatment solution at a concentration included in the range from 0.001% to 1% by weight, relative to the total weight of the surface treatment solution.

The applicant actually noted that on this side of this range of concentrations, the agent does not emit a sufficient amount of light to be easily discerned with the naked eye under UV radiation. Beyond this range of concentrations, the agent runs the risk of altering the effectiveness of the operations that the surfaces to be treated are to undergo subsequently, such as, for example, an operation of painting, gluing, sealing or else flaming.

The wipe according to this invention comprises a surface treatment solution.

In a first embodiment, this solution is advantageously an aqueous solution that comprises at least one active agent that is selected from among, for example, non-ionic, anionic, cationic or amphoteric surfactants. The latter are present in the surface treatment solution of 0.001 to 1% by weight, relative to the total weight of said surface treatment solution.

In a second embodiment, the surface treatment solution comprises at least one non-aqueous cleaning solvent that is selected from, for example, the group of aromatic or aliphatic hydrocarbons, petroleum solvents, alcohols, ketones, esters, ethers, such as a glycol ether.

More particularly, this solvent consists of a single raw material, such as heptane, isopropanol, or else a mixture of oxygenated and/or hydrocarbon-containing organic solvents or aqueous base formulations.

Examples of cleaning solvent formulations that are suitable for this invention can be the product marketed under the trademark Diestone® DLS by the SOCOMOR Company.

This type of solvent has the advantage of degreasing the surface to be treated.

The surface treatment solution may also comprise other compounds, usually used in the field of surface treatments and well known to one skilled in the art, such as oils, adhesion promoters, demolding agents or anti-corrosion agents, mineral salts, . . . .

This invention also has as its object a process for the production of a wipe according to one of the characteristics above.

This process comprises at least the steps of:
a) Dissolving a light-emitting agent that is visible at least under predetermined conditions in a surface treatment solution,
b) Impregnating, up to a determined level, the wipe with the solution that is thus obtained,
c) Packaging said wipe that is impregnated in an airtight package that is compatible with said solution that is obtained,
   whereby steps b) and c) can be carried out in any order.

In a first embodiment, the impregnation stage can be carried out before packaging the impregnated wipe in an airtight package.

Thus, according to this first embodiment, the impregnation step can be carried out first by pumping the surface treatment solution through a filter (5 to 50 μm), then by filling the package that contains the wipe or wipes, whereby the delivered volume is monitored by a flowmeter.

For example, the package that is compatible with said solution that is obtained in step a) is of the heat-sealed type.

In a second embodiment, the impregnation step can be carried out after the wipes are packaged.

In this latter case, the wipes are generally placed in the package that is compatible with said solution, so that each wipe is impregnated with said solution. They are also precut so as to make their use easier. Then, the solution that is obtained in step a) is injected into the package so as to saturate the packages.

The distributor that is particularly suitable for this type of packaging can be a bucket. This packaging has a very special advantage for applications in the industrial field.

In the two embodiments as described above, the impregnation should be done so as to distribute homogeneously the solution that is obtained in step a) from the process on said wipe.

In a general way, the impregnation rate of the surface treatment solution, expressed by mass of surface treatment solution per unit of wipe mass, is between 1 g/g and 10 g/g. The impregnation process is also carried out in a controlled work environment.

These operations can actually be carried out in a module that is divided into three separate parts:
A “man” airlock in which the operators outfit themselves with an entire suit of shoe-covers, mobcap, gloves and glasses before entering the saturation room.
A “component” airlock, by which all of the components are introduced into the saturation room.
A saturation room, in which the saturation of the wipe and the sealing of the package are carried out, whereby the saturation room is put into overpressure so as to prevent any introduction of particles and dust able to contaminate the wipes.

This clean work environment offers the advantage of maintaining a high level of quality of the finished product, which is necessary for use in preparing a surface to be treated, for example before putting under paint, gluing, sealing or else flaming.

Use of wipes will now be described below:

During the use of the wipe according to this invention and as produced according to the process above, the dirt marks that are present on a surface, such as a plastic or metallic surface, are removed by the chemical action of the solvent and by the mechanical action of the wipe. During this step, the light-emitting agent is placed on or is fixed to the cleaned surface.

Then, the use of UV radiation above the cleaned surface makes it possible to visualize all the areas where the light-emitting agent is placed and/or fixed.

Consequently, the areas that do not have light emission are:
Either areas that have not been treated, i.e., where the wipe has not yet passed over according to this invention,
Or areas that have not been correctly treated. For example, this state may correspond to the fact that the action of the wipe combined with that of the solvent has not been sufficient to remove all the dirt marks; however, the latter prevent the fixing or the deposition of the light-emitting agent on the cleaned surface.

Thus, the wipe according to this invention, in a preferred embodiment, preferably comprises: a UV fluorescent agent, at least one solvent, a non-woven-type substrate, a flexible package, for example heat-sealable so as to form a wipe distributor.

A wipe according to this invention and therefore presaturated with a surface treatment solution and a light-emitting agent distributed homogeneously over said substrate, has various advantages:
First, the consumption of the surface treatment solution is reduced. The application actually noted a reduction ranging up to 80-90% relative to the traditional methods, i.e., relative to the use of a dry cloth combined with a conventional-type liquid product.
Then, in the same way, a reduction of COV emissions was noted,
Just like a reduction of the amount of waste. The non-woven wipe actually has a total surface area that generally varies from 0.01 m² to 0.1 m² for a weight of 30 g/m² to 80 g/m², whereas the currently used cloths have a surface area of 0.1 m² to 0.2 m² for a weight of about 150 g/m².
The use of presaturated wipes makes it possible to eliminate any operation of transfer and handling of inflammable products and/or products that are dangerous to man and the environment.
Primarily, it makes possible a better control of the methods and processes. As indicated above, the surface preparation before painting or gluing is a deciding stage in the quality of said operations. However, the wipe according to this invention makes it possible to identically reproduce each surface treatment operation (regardless of the operator) by using wipes of an identical predetermined size, containing a concentration (predetermined and identical) of surface treatment solution that is distributed homogeneously over the wipe, itself containing a predetermined and homogeneous concentration of a light-emitting agent.
The wipe according to this invention that comprises the light-emitting agent also makes possible the instantaneous and/or a posteriori verification of the operation for surface preparation before painting or gluing. Actually, the use of said wipes makes it possible to place and/or to fix homogeneously the light-emitting agent on the entire treated surface. Thus, if the surface treatment operation is done under UV radiation, the verification may be instantaneous. It can also be done a posteriori by subjecting the presumed treated piece to UV radiation, since the light-emitting agent is permanently fixed to the cleaned surface.
This verification finally makes it possible to detect the non-treated areas. Actually, in these areas, the light-emitting agent is not fixed, and there is therefore no emission of visible light under UV radiation. This verification also makes it possible to distinguish incorrectly-treated areas from correctly-treated areas. In the former, the agent that is fixed homogeneously to the surface therefore emits a “continuous film” of light. By contrast, in the “incorrectly-treated” areas, the light-emitting agent is fixed heterogeneously. Under UV radiation, these areas are characterized by an “intermittent film of light” shown, for example, by aureoles, very bright droplets or dark areas.

In conclusion, the use of wipes that are impregnated with a surface treatment solution that comprises a light-emitting agent according to this invention makes possible a visual, rapid and simple verification of the surface preparation operation before, in particular, operations of painting or else gluing, sealing or flaming.

Examples are proposed so as to illustrate the invention, but in no case aim to limit the scope of the invention.

### EXAMPLE 1

A mixture of heptane and 2,5-thiophenediylbis(5-tert-butyl-1,3-benzoxazole) of a concentration of between 0.05 and 0.2% is impregnated at a concentration varying from 2 to 4 g/g in a precut roll of 100 wipes measuring 6″×9″, non-woven, 100% vented rayon.

The packaging is done in a 4-layer pack (polyester/aluminum/polyamide/polyethylene) with a thickness that can vary from 100 to 150 μm, hermetically heat-sealed.

### EXAMPLE 2

A mixture of Diestone® DLS, which corresponds to a mixture of solvents marketed by the SOCOMOR Company and 2,5-thiophenediylbis(5-tert-butyl-1,3-benzoxale) of a concentration that varies between 0.05% and 0.2%, was impregnated at a concentration of 2 to 4 g/g in a precut roll of 250 wipes measuring 6″×4.25″, non-woven 60% cellulose/40% polyester.

The packaging is carried out in a 4-layer pack based on polyester/aluminum/polyamide/polyethylene with a thickness that varies from 100 to 150 μm, hermetically heat-sealed.

### EXAMPLE 3

A mixture of isopropanal (70 to 100%), demineralized water (0 to 30%) and sodium salt of 4,4′-bis(2-sulfostyryl)-biphenyl (0.05% to 0.2%) was impregnated at a concentration of 2 g/g to 4 g/g in a pack of 50 wipes that are cut and folded in 4 measuring 11″×17″, non-woven polypropylene.

The packaging is done in a 2-layer pack based on polyester/polyethylene with a thickness that varies between 100 to 150 μm, hermetically heat-sealed.

### EXAMPLE 4

A mixture of WADIS 24,® which corresponds to a mixture of solvents such as aliphatic hydrocarbons, oils and anti-corrosion agents of the sulfonate and petroleum oxidate type, marketed by the SOCOMOR Company, and 2,5-thiophenediylbis(5-tert-butyl-1,3-benzoxazle) of a concentration that varies between 0.05% and 0.2%, was impregnated at a concentration of 2 to 4 g/g in a precut roll of 70 wipes measuring 9″×11″, 100% non-woven polyester.

The packaging is done in a 4-layer pack based on polyester/aluminum/polyamide/polyethylene with a thickness that varies from 100 to 150 μm, hermetically heat-sealed.

### EXAMPLE 5

A Soco Gel® mixture that corresponds to an aqueous solution of zirconium salts activated by an organo-silicon and sodium salt compound of 4,4′-bis(2-sulfostyryl)-biphenyl (0.05% to 0.2%) of a concentration of between 0.05 and 0.2% is impregnated at a concentration that varies from 2 to 4 g/g in a precut roll of 100 wipes measuring 6″×9″, perforated, 100% nonwoven rayon.

The packaging is done in a 4-layer pack (polyester/aluminum/polyamide/polyethylene) with a thickness that can vary from 100 to 150 μm, hermetically heat-sealed.

1. Wipe for surface treatment, comprising a substrate that is impregnated with a surface treatment solution, characterized in that said wipe comprises at least one light-emitting agent, whereby said light-emitting agent is soluble in the surface treatment solution and visible at least under predetermined conditions, so that a user can verify and/or monitor the treated and/or non-treated areas of said surface.

2. Wipe according to claim 1, wherein the light-emitting agent is a fluorescent compound that absorbs the invisible UV radiations and emits visible light radiation or a phosphorescent compound.

3. Wipe according to claim 1, wherein the emitting agent is selected from the group that is formed by the 2,5-thiophenediylbis(5-tert-butyl-1,3-benzoxazole) and the disodium salt of 4,4′-bis(2-sulfostyryl)-biphenyl.

4. Wipe according to claim 1, wherein the substrate of said wipe is a woven material, non-woven material, knitted material or a composite film.

5. Wipe according to claim 1, wherein the substrate of said wipe is made of fibers of polyester, polypropylene, polyamide, viscose, rayon or other cellulose derivatives.

6. Wipe according to claim 1, wherein the light-emitting agent is present in the surface treatment solution at a concentration in the range of 0.001% to 1% by weight relative to the total weight of said surface treatment solution.

7. Wipe according to claim 1, wherein the surface treatment solution is an aqueous solution that contains, as active agent, an agent that is selected from the group of non-ionic, anionic, cationic or amphoteric surfactants.

8. Wipe according to claim 1, wherein the surface treatment solution comprises at least one non-aqueous solvent that is selected from the group of organic solvents.

9. Wipe according to claim 1, wherein the rate of impregnation of the surface treatment solution that is expressed by mass of surface treatment solution per unit of mass of wipe is between 1 g/g and 10 g/g.

10. Process for the production of a wipe according to claim 1 that comprises at least the stages that consist in:
a) Dissolving a light-emitting agent that is visible at least under
predetermined conditions in a surface treatment solution,
b) Impregnating up to a predetermined level said wipe with the solution
that is obtained, whereby the impregnation is done so as to distribute said solution homogeneously over said wipe,
c) Packaging said wipe that is impregnated in an airtight package that
is compatible with said solution,
whereby stages b) and c) can be carried out in any order.
